(19) United States
(12) Patent Application Publication
(10) Pub. No.: US 2018/0103311 A1
(43) Pub. Date: Apr. 12, 2018

(54) WEARABLE SYSTEM CONFIGURED TO RECEIVE AUDIO SIGNALS THROUGH DOCK

(71) Applicant: FuelStation Inc., Apia (WS)

(72) Inventor: Mike CHEN, New Taipei City (TW)

(73) Assignee: FuelStation Inc., Apia (WS)

(21) Appl. No.: 15/385,980

(22) Filed: Dec. 21, 2016

(30) Foreign Application Priority Data
Oct. 12, 2016 (TW) 105132866

(51) Int. Cl. H04R 1/10; H04W 4/00; H04L 29/06

(52) U.S. Cl. CPC H04R 1/1041; H04R 1/1033; H04R 1/1025; H04R 2420/07; H04L 63/0807; H04L 63/123; H04W 4/008

(57) ABSTRACT

A wearable system configured to receive audio signals through a dock includes a wearable device (e.g., earphones) and the dock. The wearable device stores user-end audio files and a token therein and has a first connection port (e.g., a pogo-pin socket). The dock has a second connection port (e.g., a pogo-pin plug) and a wireless module. Once the dock is physically connected to the wearable device, the wearable device can connect to a third-party server (e.g., KKBox) through the token and the wireless function of the dock in order to download source audio files according to the token, create the user-end audio files by encrypting the source audio files, and then store the user-end audio files, thereby allowing the user to listen to music corresponding to the user-end audio files directly through the wearable device whenever desired, without having to connect the wearable device to a smartphone.

### FIELD OF THE INVENTION

The present invention relates to a wearable system configured to receive audio signals through a dock. More particularly, the invention relates to a dock designed for and connectable to a wearable device (e.g., a pair of earphones) and including a wireless module so that, once the dock is connected to the wearable device, the wearable system can connect to a third-party server by means of a token stored in the wearable device and the wireless function of the dock in order to download source audio files, which are subsequently encrypted and stored as user-end audio files.

### BACKGROUND OF THE INVENTION

Thanks to the rapid development of microelectronics and audio compression technology, people nowadays can listen to music in ways that are far more advanced than before. Bulky and hardly movable recorders and large loudspeakers are no longer necessary: one can listen to music anytime, anywhere through a compact smart device (e.g., a smartphone, digital Walkman, or iPod) and a pair of earphones. And as earphones become more and more popular, people's dependence on earphones and the time spent wearing them are increasing. For example, many are used to wearing earphones during exercise or physical training so as to immerse themselves in a musical atmosphere or simply be ready to receive calls on their mobile phones. This change of trend of using earphones has even given rise to a particular type of earphones, namely the sports earphones, which shows the importance of earphones to modern users and a great market potential.

Earphones can be divided by their audio signal receiving methods into “wired” and “wireless”. Wired earphones rely on a physical cable to connect to a smart device and to receive audio signals therefrom and are now available in very compact designs. The cables required for the connection, however, impose restrictions on their users' body movement. Wireless earphones, on the other hand, connect to smart devices and receive audio signals therefrom through a wireless technology (typically Bluetooth) and are therefore more convenient to use and carry than their wired counterparts. Nevertheless, wireless earphones are difficult to downsize because they must be installed with batteries. In particular, the inventor of the present invention has found that both types of earphones require a smart device as a source of audio signals, and that consequently an earphone user cannot listen to music without a smart device on hand. This limitation in use hinders further development of earphones.

As a solution, the inventor of the present invention designed a pair of improved earphones and a corresponding service system as disclosed and shown in FIG. 1. The earphones A in FIG. 1 are provided therein with a storage element and a short-range wireless communication element. The storage element is configured to store audio files. The short-range wireless communication element can connect to each of the user's terminal devices B through Bluetooth, NFC, ZigBee, or other short-range transmission technology. To use the service system, the user begins by connecting any one of the terminal devices B to the Internet N, logging on to an administration server C1 and a third-party server C2 (e.g., a music streaming website such as KKBox, myMusic, Spotify, or Apple Music), and then downloading audio files from the third-party server C2 to the terminal device B. After that, the short-range wireless communication element in the earphones A is used to receive the audio files from the terminal device B so that, when the user subsequently moves away from the terminal device B to do exercise for example, he or she only has to carry the earphones A in order to listen to the music of the audio files. The earphones A thus feature great convenience of use.

The foregoing design has drastically changed not only the conventional conception of earphones but also the way earphones work, allowing earphones to function as an independent device for storing and playing music, and yet the inventor of the present invention believes there is still room for improvement. For instance, while the earphones A can play music on their own, they rely on the terminal devices B to connect to the servers C1 and C2 and to perform such operations as verification and file transmission when downloading audio files. In other words, certain functions of the earphones A cannot be carried out without the terminal devices B. The inventor of the present invention, therefore, wondered if it is possible to further improve the earphones A and greatly enhance their convenience of use by enabling them to directly connect to the servers C1 and C2 while maintaining their ease of wearing.

In order to upgrade the earphones A to a “wearable device” that has all the desired functions and meets market demands, the following issues must be addressed: How to transfer files to the wearable device? How to achieve compactness in size? And how to ensure adequate battery life? If the terminal devices B are dispensed with, it will be a huge challenge to design the verification process between the earphones A and each of the servers C1 and C2 and the file encryption process required. Moreover, although the short-range wireless communication element in the earphones A by which to connect to the terminal devices B is more energy-saving than common network modules, it still occupies a certain amount of space and hence limits the capacity of the battery that can be used. The present invention is intended to solve the aforesaid problems and provide a wearable device that features greater ease of use than the prior art.

### BRIEF SUMMARY OF THE INVENTION

According to the above, the conventional earphones depend so heavily on terminal devices that their convenience of use and portability are compromised. In the light of this, the inventor of the present invention put years of practical experience into extensive research, repeated trials, and constant improvement and finally succeeded in developing a wearable system configured to receive audio signals through a dock in order to provide better user experience.

It is an objective of the present invention to provide a wearable system configured to receive audio signals through a dock, wherein the wearable system includes a wearable device in addition to the dock. The wearable device is provided thereon with a first connection port and is provided therein at least with a first storage module, an audio playing module, a first power module, and a first microprocessor. The first storage module is configured to store at least one application program, a plurality of user-end audio files, and a token. The first microprocessor is separately and electrically connected to the first connection port, the first storage module, the audio playing module, and the first power module in order to receive driving power from the first power module, execute the application program, and play the user-end audio files through the audio playing module. The dock is provided thereon with a second connection port and is provided therein with a wireless module, wherein the second connection port can connect with the first connection port to physically connect the dock to the wearable device and thereby enable data transmission therebetween. Also, the dock can transfer the token in the wearable device to a third-party server through the wireless module in order for the third-party server to transmit a plurality of source audio files to the dock according to the token, and for the wearable device to store the source audio files as the user-end audio files. With the dock freely connectable to and detachable from the wearable device, the wearable device can easily obtain the user-end audio files and have its volume reduced for enhanced flexibility in use and portability.

Another objective of the present invention is to configure the foregoing wearable system for a first operation mode, in which the dock receives the source audio files, creates encrypted audio files by performing an encryption process on the source audio files, and transfers the encrypted audio files to the wearable device; and in which the wearable device restores the encrypted audio files to the source audio files by performing a decryption process on the encrypted audio files and stores the source audio files as the user-end audio files.

Still another objective of the present invention is to configure the foregoing wearable system for a second operation mode, in which the dock receives the source audio files, transmits the source audio files to the wearable device in order for the first microprocessor to create encrypted audio files by performing an encryption process on the source audio files and store the encrypted audio files into the first storage module as the user-end audio files; and in which the first microprocessor reads the user-end audio files upon receiving a playing instruction, restores the user-end audio files to the source audio files by performing a decryption process on the user-end audio files, and transmits the source audio files to the audio playing module in order for the audio playing module to play the source audio files.

### BRIEF DESCRIPTION OF THE SEVERAL VIEWS OF THE DRAWINGS

The technical features, operation modes, and design objectives of the present invention can be better understood by referring to the detailed description of some illustrative embodiments in conjunction with the accompanying drawings, in which:

FIG. 1 schematically shows the earphones and service system previously designed by the inventor of the present invention;

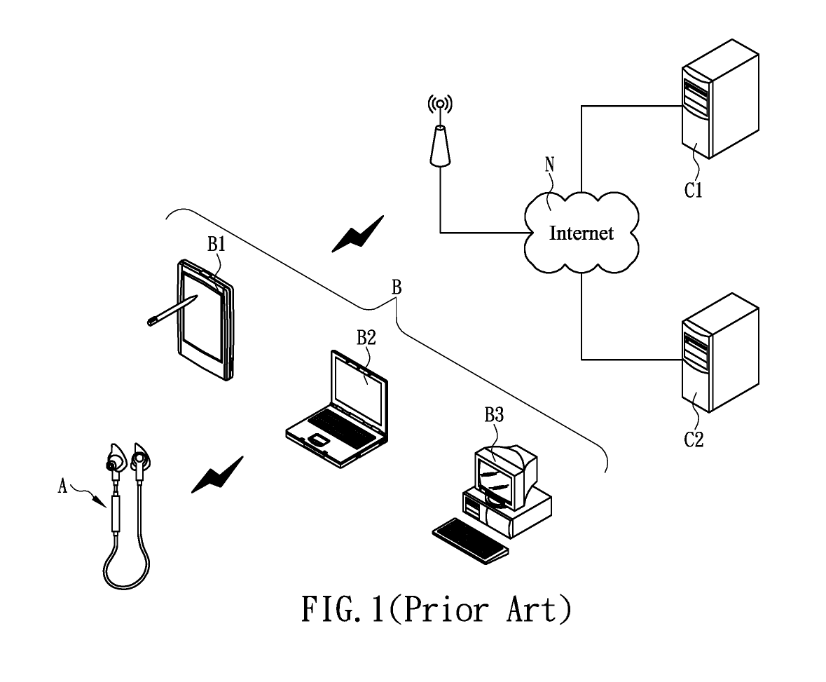

FIG. 2 schematically shows the wearable system in the first preferred embodiment of the present invention;

FIG. 3 schematically shows the wearable system in the second preferred embodiment of the present invention; and

FIG. 4 schematically shows the wearable system in the third preferred embodiment of the present invention.

### DETAILED DESCRIPTION OF THE INVENTION

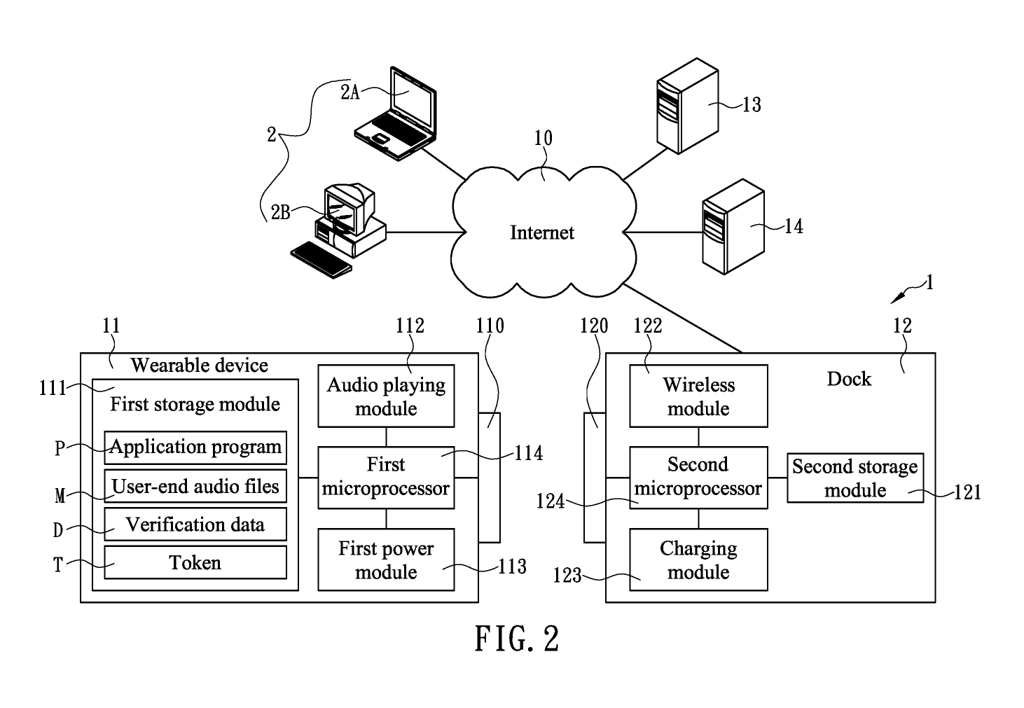

The present invention provides a wearable system configured to receive audio signals through a dock. Referring to FIG. 2 for the first preferred embodiment of the invention, the wearable system 1 includes a wearable device 11 (e.g., a pair of earphones) and a dock 12. The wearable device 11 is provided thereon with a first connection port 110, which may be a pogo-pin socket, magnetic connector, USB interface (e.g., USB, Micro-USB, or USB Type-C) socket, or other similar physical connection structure configured for data transmission. The wearable device 11 is provided therein with a first storage module 111, an audio playing module 112, a first power module 113, and a first microprocessor 114. The first storage module 111 is configured to store at least one application program P (e.g., an audio playing program), a plurality of user-end audio files M, at least one entry of verification data D (e.g., a user profile or the machine number of the wearable system 1), and a token T. The way the user-end audio files M, the verification data D, and the token T are stored will be detailed further below.

The audio playing module 112 is configured to play the user-end audio files M stored in the storage module 111. The first microprocessor 114 is separately and electrically connected to the first connection port 110, the first storage module 111, the audio playing module 112, and the first power module 113 in order to receive driving power from the first power module 113, execute the application program P, and play the user-end audio files M through the audio playing module 112.

The dock 12 is provided thereon with a second connection port 120. The second connection port 120 corresponds in form to the first connection port 110 and may be a pogo-pin plug, magnetic connector, USB interface (e.g., USB, Micro-USB, or USB Type-C) plug, or other similar physical connection structure designed to connect with the first connection port 110 so that the dock 12 can be physically connected to, and carry out data transmission to and from, the wearable device 11 (in this embodiment, the connection ports 110 and 120 are configured to transmit both data and electricity).

Provided in the dock 12 are a second storage module 121, a wireless module 122, a charging module 123, and a second microprocessor 124. The wireless module (e.g., a WiFi module) is configured to connect to an administration server 13 and a third-party server 14 (e.g., KKBox, myMusic, Spotify, or Apple Music) through the Internet 10. The charging module 123 may be a charging circuit and a connector socket to be electrically connected to an external power source (e.g., a mobile power pack).

The second microprocessor 124 is separately and electrically connected to the second connection port 120, the second storage module 121, the wireless module 122, and the charging module 123, in order for the dock 12 to transfer the token T in the wearable device 11 to the third-party server 14 through the wireless module 122, for the third-party server 14 to transmit a plurality of source audio files to the dock 12 according to the token T, and for the wearable device 11 to store the source audio files as the user-end audio files M. The wearable system 1 can operate in either of the following two modes:

(1) In the first operation mode, the second microprocessor 124 acquires the verification data D in the wearable device 11 through the second connection port 120 and connects with the administration server 13 via the wireless module 122 in order for the administration server 13 to identify the user's account according to the verification data D. Once the user account is identified, the administration server 13 feeds back with the token T. The second microprocessor 124 can later retrieve, through the second connection port 120, the token T stored in the wearable device 11 and connect with the third-party server 14 through the wireless module 122 in order to download a plurality of source audio files (e.g., the user's list of music and the corresponding mp3 audio files) to the wearable system 1 according to the token T. The wearable device 11 then stores the source audio files as the user-end audio files M (the conversion from the source audio files to the user-end audio files and the storage of the user-end audio files will be dealt with at length further below).

(2) In the second operation mode, the entire process is dominated by the first microprocessor 114. To start with, the first microprocessor 114 connects with the second microprocessor 124 and the wireless module 122 (both of which can be integrated into a single chip) through the connection ports 110 and 120 in order to connect with the administration server 13 by means of the connection function of the dock 12 and obtain the token T from the administration server 13 according to the verification data D. The first microprocessor 114 can later reconnect with the second microprocessor 124 and the wireless module 122 through the connection ports 110 and 120 in order to connect with the third-party server 14 and download a plurality of source audio files to the wearable system 1 according to the token T. The source audio files are subsequently stored as the user-end audio files M.

In either of the two operation modes, the wearable system 1 can obtain audio files from the third-party server 14 independently without using a terminal device (e.g., a smartphone) as a means of transmission. More particularly, the wearable device 11 acquires the user-end audio files M by downloading the source audio files from the third-party server 14 through the dock 12. Once the user-end audio files M are stored in the wearable device 11, the dock 12 can be detached from the wearable device 11 and put into a pocket or backpack, allowing the user to carry only the wearable device 11 in order to listen to music wherever and whenever desired. Moreover, the absence of a wireless transmission module in the wearable device 11 makes it possible to downsize the wearable device 11 and lower its power consumption.

The wearable device 11 may alternatively be provided with a plurality of first connection ports 110 (e.g., a plurality of pogo-pin connectors or USB sockets) so that, when the first power module 113 in the wearable device 11 is short of electricity, an external power source (e.g., mains electricity or a mobile power pack) can be connected to a corresponding one of the first connection ports 110 to charge the first power module 113 directly. Or, the dock 12 may be connected to a corresponding one of the first connection ports 110, and the external power source, to the charging module 123 of the dock 12 in order to supply electricity to the wearable device 11 indirectly, i.e., through the dock 12. The “wireless transmission” and “charging” functions of the dock 12 allow the wearable device 11 to have a compact design and a flexibly extendable battery life.

To shed more light on the operation of the wearable system 1, a detailed description of how a user establishes the verification data D is given below. Referring to FIG. 2, when a user uses the administration server 13 for the first time, it is still required that he or she connect a terminal device 2 (e.g., a laptop computer 2A, personal computer 2B, or smartphone) to the administration server 13 and the third-party server 14 and register a user account in each server (the two servers may share a common user account or use separate user accounts, depending on the cooperation agreement between the server operators). The user may also use the terminal device 2 to edit his or her own list of music and favorite options in the services provided by the administration server 13 and the third-party server 14. Then, the user sends a request message to the third-party server 14 through the terminal device 2 in order to receive the token T provided by the third-party server 14, wherein the token T may have a limited period of validity (e.g., one week or one month).

The terminal device 2 will redirect the token T to the administration server 13 to complete the binding of the user account(s) to the two servers 13 and 14. Once the user purchases the wearable system 1, he or she may further register the machine number of the wearable system 1 to the administration server 13 or store the verification data D corresponding to the user account(s) (e.g., the account name(s) and the corresponding password(s), or an encryption key) into the wearable device 11 through wireless transmission. When the dock 12 is subsequently connected to the administration server 13, the administration server 13 can identify the user's user account(s) by the verification data D and provide the token T to the wearable system 1.

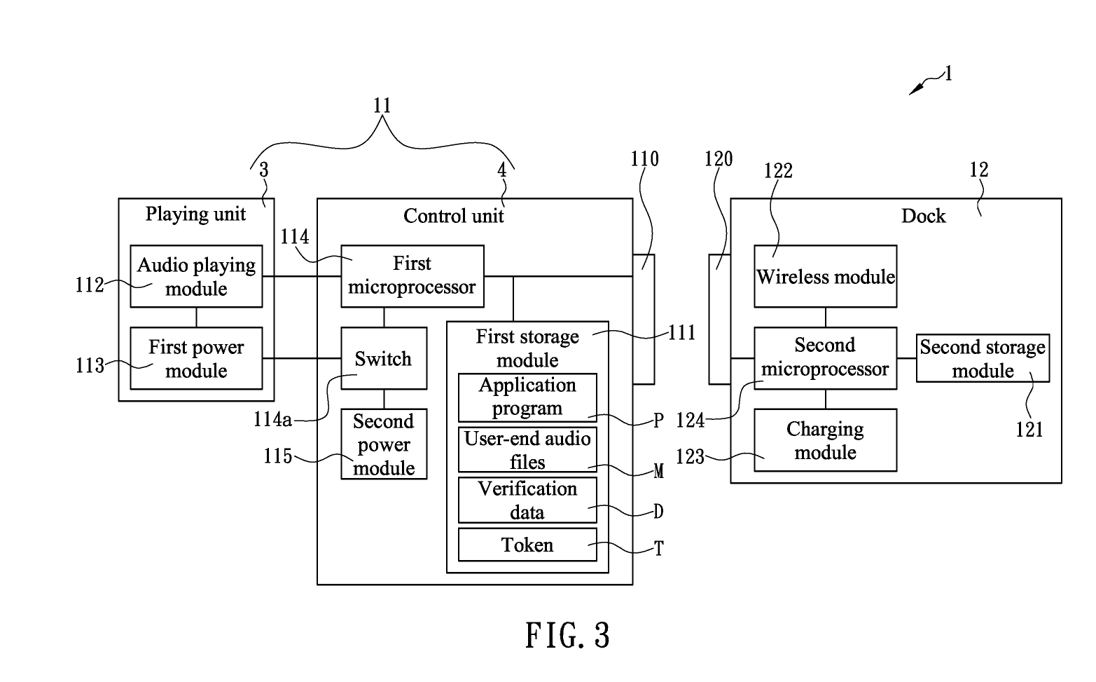

It is worth mentioning that the wearable device 11 is not necessarily a single device enclosed in a housing. Referring to FIG. 3 for the wearable system 1 in the second preferred embodiment of the present invention, the wearable device 11 in this embodiment includes a playing unit 3 (e.g., the main body of a pair of earphones) and a control unit 4 (e.g., a controller provided at a cable end). The playing unit 3 and the control unit 4 are enclosed in different housings respectively and are connected to each other by wires. The audio playing module 112 and the first power module 113 are provided in the playing unit 3 while the first storage module 111 and the first microprocessor 114 are provided in the control unit 4. The first connection port 110 is provided on the control unit 4.

Apart from that, referring to FIG. 2 and FIG. 3, the wearable system 1 can further encrypt the files received in order to prevent those with ill intentions from obtaining the user-end audio files M illegally, e.g., by disassembling the dock 12. The encryption process corresponding to each of the two operation modes of the present invention is as follows:

(1) In the first operation mode, the source audio files (e.g., mp3 files) downloaded from the third-party server 14 to the dock 12 are encrypted by the second microprocessor 124 (the files may be temporarily stored in the second storage module 121) to create encrypted audio files (e.g., in compliance with the Advanced Encryption Standard, or AES), which are provided to the wearable device 11. Upon receiving the encrypted audio files, the first microprocessor 114 of the wearable device 11 performs a decryption process on the encrypted audio files to restore the encrypted audio files to the source audio files (e.g., mp3 files). After that, the first microprocessor 114 stores the source audio files into the first storage module 111 as the user-end audio files M, which can be directly played by the first microprocessor 114 whenever desired.

(2) In the second operation mode, the source audio files downloaded from the third-party server 14 to the dock 12 are directly transferred by the dock 12 to the wearable device 11, in order for the first microprocessor 114 of the wearable device 11 to create encrypted audio files by performing an encryption process on the source audio files and store the encrypted audio files into the first storage module 111 as the user-end audio files M. When the user wishes to listen to music, the first microprocessor 114 reads the user-end audio files M in the first storage module 111 according to the playing instruction received and performs a decryption process on the user-end audio files M to restore the user-end audio files to the source audio files, which are then transmitted to and played by the audio playing module 112.

In the embodiment where the wearable device 11 is divided into the playing unit 3 and the control unit 4, each of the playing unit 3 and the control unit 4 may be installed with a battery. That is to say, in addition to the first power module 113 in the playing unit 3, the control unit 4 may be provided therein with a second power module 115, wherein the second power module 115 is electrically connected to the first microprocessor 114. When the wearable device 11 is turned on, the first microprocessor 114 uses the driving power of the first power module 113 to begin with. When determining that the first power module 113 is short of power (e.g., with a power level lower than 5%), the first microprocessor 114 operates a switch 114a and uses the power of the second power module 115 instead.

Once the dock 12 is connected to the control unit 4 and starts charging the wearable device 11, and the wearable device 11 has received the supply power delivered through the dock 12, the first microprocessor 114 stores the supply power into the first power module 113 and the second power module 115 rather than using the supply power directly to drive the audio playing module 112.

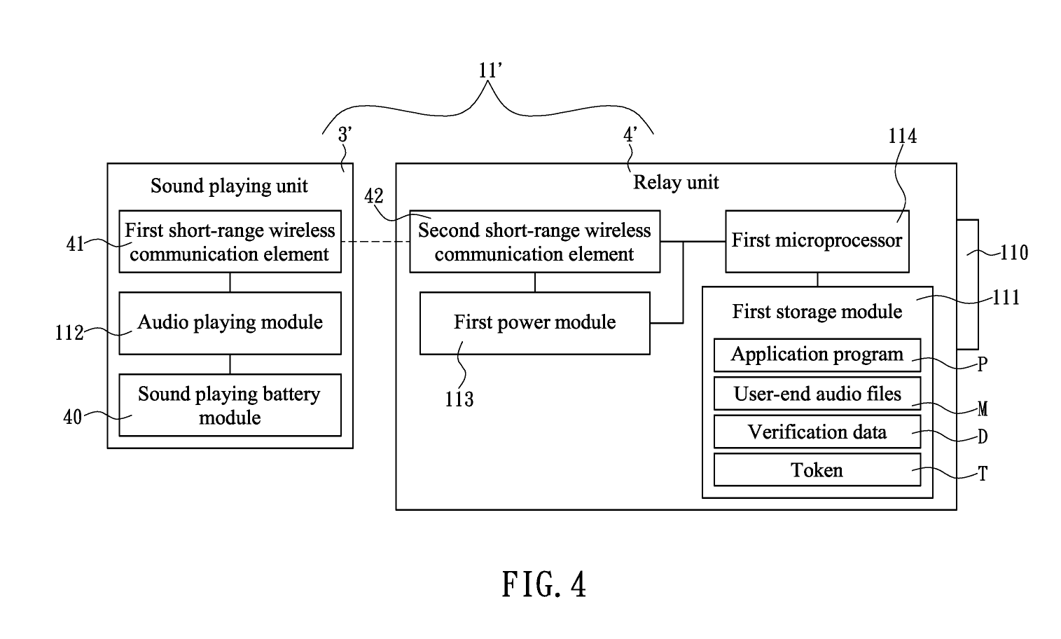

FIG. 4 shows the third preferred embodiment of the present invention, in which the wearable device 11′ includes a sound playing unit 3′ and a relay unit 4′. The sound playing unit 3′ may be a pair of Bluetooth earphones, and the relay unit 4′, a wearable bracelet. The sound playing unit 3′ is provided therein with the audio playing module 112, a first short-range wireless communication element 41, and a sound playing battery module 40. The audio playing module 112 is electrically connected to the first short-range wireless communication element 41 and the sound playing battery module 40 and can be driven by the power provided by the sound playing battery module 40.

The relay unit 4′ is provided therein with the first power module 113, the first storage module 111, the first microprocessor 114, and a second short-range wireless communication element 42. Also, the first connection port 110 is provided on the relay unit 4′ to enable physical connection with the dock 12 (see FIG. 2). The short-range wireless communication elements 41 and 42 can connect with each other through a short-range wireless communication technology (e.g., one in compliance with the Bluetooth, Near Field Communication (NFC), ZigBee, or ANT network protocol, wherein ANT is designed by Dynastream Innovations) to carry out data transmission therebetween. Thus, the relay unit 4′ can transfer the user-end audio files M to the sound playing unit 3′ through the short-range wireless communication elements 41 and 42 in order for the audio playing module 112 to play the corresponding sound.

While the invention herein disclosed has been described by means of specific embodiments, numerous modifications and variations could be made thereto by those skilled in the art without departing from the scope of the invention set forth in the claims.

What is claimed is:

1. A wearable system configured to receive audio signals through a dock, comprising:
a wearable device provided thereon with a first connection port, the wearable device being provided therein at least with:
a first storage module for storing at least one application program, a plurality of user-end audio files, and a token;
an audio playing module for playing the user-end audio files stored in the first storage module;
a first power module; and
a first microprocessor separately and electrically connected to the first connection port, the first storage module, the audio playing module, and the first power module in order to receive driving power from the first power module, execute the application program, and play the user-end audio files through the audio playing module; and
the dock provided thereon with a second connection port, the dock being provided therein with a wireless module, wherein the second connection port is connectable with the first connection port to physically connect the dock to the wearable device and thereby enable data transmission therebetween, and the dock is configured to transfer the token in the wearable device to a third-party server through the wireless module in order for the third-party server to transmit a plurality of source audio files to the dock according to the token, and for the wearable device to store the source audio files as the user-end audio files.

2. The wearable system of claim 1, wherein after receiving the source audio files, the dock creates encrypted audio files by performing an encryption process on the source audio files and transfers the encrypted audio files to the wearable device.

3. The wearable system of claim 2, wherein upon receiving the encrypted audio files, the wearable device restores the encrypted audio files to the source audio files by performing a decryption process on the encrypted audio files and stores the source audio files into the first storage module as the user-end audio files.

4. The wearable system of claim 1, wherein after receiving the source audio files, the dock transmits the source audio files to the wearable device in order for the first microprocessor to create encrypted audio files by performing an encryption process on the source audio files and store the encrypted audio files into the first storage module as the user-end audio files.

5. The wearable system of claim 4, wherein upon receiving a playing instruction, the first microprocessor reads the user-end audio files in the first storage module, restores the user-end audio files to the source audio files by performing a decryption process on the user-end audio files, and transmits the source audio files to the audio playing module in order for the audio playing module to play the source audio files.

6. The wearable system of claim 1, wherein the first storage module further stores verification data, and the dock is configured to transfer the verification data in the wearable device to an administration server through the wireless module in order to obtain the token from the administration server and store the token into the first storage module.

7. The wearable system of claim 2, wherein the first storage module further stores verification data, and the dock is configured to transfer the verification data in the wearable device to an administration server through the wireless module in order to obtain the token from the administration server and store the token into the first storage module.

8. The wearable system of claim 3, wherein the first storage module further stores verification data, and the dock is configured to transfer the verification data in the wearable device to an administration server through the wireless module in order to obtain the token from the administration server and store the token into the first storage module.

9. The wearable system of claim 4, wherein the first storage module further stores verification data, and the dock is configured to transfer the verification data in the wearable device to an administration server through the wireless module in order to obtain the token from the administration server and store the token into the first storage module.

10. The wearable system of claim 5, wherein the first storage module further stores verification data, and the dock is configured to transfer the verification data in the wearable device to an administration server through the wireless module in order to obtain the token from the administration server and store the token into the first storage module.

11. The wearable system of claim 6, wherein the dock further comprises a second microprocessor, and the second microprocessor is configured to obtain the token from the wearable device through the connection ports and transfer the token to the third-party server in order to download the source audio files.

12. The wearable system of claim 7, wherein the dock further comprises a second microprocessor, and the second microprocessor is configured to obtain the token from the wearable device through the connection ports and transfer the token to the third-party server in order to download the source audio files.

13. The wearable system of claim 8, wherein the dock further comprises a second microprocessor, and the second microprocessor is configured to obtain the token from the wearable device through the connection ports and transfer the token to the third-party server in order to download the source audio files.

14. The wearable system of claim 9, wherein the dock further comprises a second microprocessor, and the second microprocessor is configured to obtain the token from the wearable device through the connection ports and transfer the token to the third-party server in order to download the source audio files.

15. The wearable system of claim 10, wherein the dock further comprises a second microprocessor, and the second microprocessor is configured to obtain the token from the wearable device through the connection ports and transfer the token to the third-party server in order to download the source audio files.

16. The wearable system of claim 11, wherein the wearable device comprises a playing unit and a control unit, the playing unit and the control unit are enclosed in different housings respectively and are connected to each other by wires, the audio playing module and the first power module are provided in the playing unit, the first storage module and the first microprocessor are provided in the control unit, and the first connection port is provided on the control unit.

17. The wearable system of claim 12, wherein the wearable device comprises a playing unit and a control unit, the playing unit and the control unit are enclosed in different housings respectively and are connected to each other by wires, the audio playing module and the first power module are provided in the playing unit, the first storage module and the first microprocessor are provided in the control unit, and the first connection port is provided on the control unit.

18. The wearable system of claim 13, wherein the wearable device comprises a playing unit and a control unit, the playing unit and the control unit are enclosed in different housings respectively and are connected to each other by wires, the audio playing module and the first power module are provided in the playing unit, the first storage module and the first microprocessor are provided in the control unit, and the first connection port is provided on the control unit.

19. The wearable system of claim 14, wherein the wearable device comprises a playing unit and a control unit, the playing unit and the control unit are enclosed in different housings respectively and are connected to each other by wires, the audio playing module and the first power module are provided in the playing unit, the first storage module and the first microprocessor are provided in the control unit, and the first connection port is provided on the control unit.

20. The wearable system of claim 15, wherein the wearable device comprises a playing unit and a control unit, the playing unit and the control unit are enclosed in different housings respectively and are connected to each other by wires, the audio playing module and the first power module are provided in the playing unit, the first storage module and the first microprocessor are provided in the control unit, and the first connection port is provided on the control unit.

21. The wearable system of claim 16, wherein the wearable device further comprises a second power module, the second power module is provided in the control unit and is electrically connected to the first microprocessor, and the first microprocessor uses the driving power of the first power module to begin with and will not use supply power provided by the second power module until the first microprocessor determines that the first power module is short of power.

22. The wearable system of claim 17, wherein the wearable device further comprises a second power module, the second power module is provided in the control unit and is electrically connected to the first microprocessor, and the first microprocessor uses the driving power of the first power module to begin with and will not use supply power provided by the second power module until the first microprocessor determines that the first power module is short of power.

23. The wearable system of claim 18, wherein the wearable device further comprises a second power module, the second power module is provided in the control unit and is electrically connected to the first microprocessor, and the first microprocessor uses the driving power of the first power module to begin with and will not use supply power provided by the second power module until the first microprocessor determines that the first power module is short of power.

24. The wearable system of claim 19, wherein the wearable device further comprises a second power module, the second power module is provided in the control unit and is electrically connected to the first microprocessor, and the first microprocessor uses the driving power of the first power module to begin with and will not use supply power provided by the second power module until the first microprocessor determines that the first power module is short of power.

25. The wearable system of claim 20, wherein the wearable device further comprises a second power module, the second power module is provided in the control unit and is electrically connected to the first microprocessor, and the first microprocessor uses the driving power of the first power module to begin with and will not use supply power provided by the second power module until the first microprocessor determines that the first power module is short of power.

26. The wearable system of claim 21, wherein the dock comprises a charging module electrically connectable to an external power source in order to receive supply power from the external power source and deliver the supply power to the wearable device through the connection ports, and when the wearable device receives the supply power from the dock, the first microprocessor stores the supply power into the first power module or the second power module.

27. The wearable system of claim 22, wherein the dock comprises a charging module electrically connectable to an external power source in order to receive supply power from the external power source and deliver the supply power to the wearable device through the connection ports, and when the wearable device receives the supply power from the dock, the first microprocessor stores the supply power into the first power module or the second power module.

28. The wearable system of claim 23, wherein the dock comprises a charging module electrically connectable to an external power source in order to receive supply power from the external power source and deliver the supply power to the wearable device through the connection ports, and when the wearable device receives the supply power from the dock, the first microprocessor stores the supply power into the first power module or the second power module.

29. The wearable system of claim 24, wherein the dock comprises a charging module electrically connectable to an external power source in order to receive supply power from the external power source and deliver the supply power to the wearable device through the connection ports, and when the wearable device receives the supply power from the dock, the first microprocessor stores the supply power into the first power module or the second power module.

30. The wearable system of claim 25, wherein the dock comprises a charging module electrically connectable to an external power source in order to receive supply power from the external power source and deliver the supply power to the wearable device through the connection ports, and when the wearable device receives the supply power from the dock, the first microprocessor stores the supply power into the first power module or the second power module.

31. The wearable system of claim 11, wherein the wearable device comprises:
a sound playing unit provided therein with the audio playing module, a first short-range wireless communication element, and a sound playing battery module, wherein the audio playing module is electrically connected to the first short-range wireless communication element and the sound playing battery module and is configured to be driven by power provided by the sound playing battery module; and
a relay unit provided therein with the first power module, the first storage module, the first microprocessor, and a second short-range wireless communication element, the relay unit being provided thereon with the first connection port, the relay unit being configured to transfer the user-end audio files to the sound playing unit through connection between the short-range wireless communication elements.

32. The wearable system of claim 12, wherein the wearable device comprises:
a sound playing unit provided therein with the audio playing module, a first short-range wireless communication element, and a sound playing battery module, wherein the audio playing module is electrically connected to the first short-range wireless communication element and the sound playing battery module and is configured to be driven by power provided by the sound playing battery module; and
a relay unit provided therein with the first power module, the first storage module, the first microprocessor, and a second short-range wireless communication element, the relay unit being provided thereon with the first connection port, the relay unit being configured to transfer the user-end audio files to the sound playing unit through connection between the short-range wireless communication elements.

33. The wearable system of claim 13, wherein the wearable device comprises:
a sound playing unit provided therein with the audio playing module, a first short-range wireless communication element, and a sound playing battery module, wherein the audio playing module is electrically connected to the first short-range wireless communication element and the sound playing battery module and is configured to be driven by power provided by the sound playing battery module; and
a relay unit provided therein with the first power module, the first storage module, the first microprocessor, and a second short-range wireless communication element, the relay unit being provided thereon with the first connection port, the relay unit being configured to transfer the user-end audio files to the sound playing unit through connection between the short-range wireless communication elements.

34. The wearable system of claim 14, wherein the wearable device comprises:
a sound playing unit provided therein with the audio playing module, a first short-range wireless communication element, and a sound playing battery module, wherein the audio playing module is electrically connected to the first short-range wireless communication element and the sound playing battery module and is configured to be driven by power provided by the sound playing battery module; and
a relay unit provided therein with the first power module, the first storage module, the first microprocessor, and a second short-range wireless communication element, the relay unit being provided thereon with the first connection port, the relay unit being configured to transfer the user-end audio files to the sound playing unit through connection between the short-range wireless communication elements.

35. The wearable system of claim 15, wherein the wearable device comprises:
a sound playing unit provided therein with the audio playing module, a first short-range wireless communication element, and a sound playing battery module, wherein the audio playing module is electrically connected to the first short-range wireless communication element and the sound playing battery module and is configured to be driven by power provided by the sound playing battery module; and
a relay unit provided therein with the first power module, the first storage module, the first microprocessor, and a second short-range wireless communication element, the relay unit being provided thereon with the first connection port, the relay unit being configured to transfer the user-end audio files to the sound playing unit through connection between the short-range wireless communication elements.
